(19) United States
(12) Patent Application Publication
(10) Pub. No.: US 2022/0355618 A1
(43) Pub. Date: Nov. 10, 2022

(54) WORMSCREW FOR DISPLACEMENT OF WHEEL

(71) Applicant: WHEEL.ME AS, Oslo (NO)

(72) Inventor: Rolf LIBAKKEN, Båtsfjord (NO)

(21) Appl. No.: 17/621,543

(22) PCT Filed: Jun. 25, 2020
(86) PCT No.: PCT/EP2020/067974

§ 371 Date: Dec. 21, 2021

(30) Foreign Application Priority Data
Jun. 27, 2019 (NO) 20190806

(51) Int. Cl. B60B 33/00; B60K 7/00

(52) U.S. Cl. CPC B60B 33/0028; B60B 33/0047; B60K 7/00; B60K 2007/0038

(57) ABSTRACT

A rolling device having a bearing housing accommodating a wheel axle carrying a wheel element, axle support members rotatably accommodated in the bearing housing and supporting the wheel axle, end portions of the wheel axle being connected to the axle support members in an eccentric position displaced from the rotational axis/4 line of the axle support members, a drive wheel connected to one of the axle support members for the axle support member to rotate following the rotation of the drive wheel, a first drive motor having a spindle engaged with the drive wheel to rotate the drive wheel and thereby the axle support member relative to the bearing housing, to displace the wheel element by eccentric movement between an extended position where at least a portion of the wheel element projects outside the bearing housing and a retracted position where the wheel element is located inside the bearing housing.

### TECHNICAL FIELD

The present invention concerns a rolling device for mounting to or integration into a device for enabling the movement of device along a surface.

More specifically the device to be moved may be a piece of furniture, interior building element such as a wall or a door. The device to be moved may also be located out of doors for instance euro pallet or may comprise other devices that are cumbersome to move.

The invention is suitable for moving all kind of devices that is to be moved between different locations outdoors and indoors, where the movement is to occur along a surface, for instance a floor.

### BACKGROUND

Various devices and especially furniture, are provided with wheels for facilitating the movement of devices from one location to another, for instance for regrouping devices or moving a device to get access to the space the device occupies or to the device itself.

The applicant has previously developed a rolling device capable of being integrated in devices, such as a piece of furniture, a movable wall etc., for moving the device along a surface, and which can be used by everyone regardless of physical condition and capacity to lift different devices in which the rolling device is integrated. This device is described in Norwegian Patent NO 316760 B 1.

The rolling device of NO 316760 B 1 comprises a cylindrical sleeve device for mounting in, for example, the leg of a piece of furniture, and a piston that is movably arranged in the cylindrical sleeve device. A ball-shaped or spherical wheel is arranged in the piston. The piston is movable, with the aid of a click system comprising a spring, between an upper position and a lower position. When the piston is in the lower position, the piece of furniture can be rolled across the floor it is standing on, whilst when the piston is in the upper position, the wheel is inside the cylindrical sleeve device and the leg of the piece of furniture, in which the rolling device is arranged, thus stands on the floor. The piece of furniture thus stands in the desired position without rolling inadvertently across the floor when small forces are applied to the piece of furniture. The solution is completely mechanical.

The applicant has further developed the concept and provided a rolling device with an automatic actuator system for moving a piston with a rolling element between an upper and lower position. This concept is disclosed in EP 3102429. The upper position is a passive stationary position where the wheel element is retracted in the rolling device, and the lower position is an active position for moving the rolling device along a surface. The actuator can be wirelessly controlled.

The present invention is a further development of the concept, providing an alternative solution for the arrangement of displacing the wheel element between a retracted position where the wheel element is prevented from moving along a surface and an extended position where the wheel element is prepared for movement along the surface.

The object of the present invention is therefore to provide a rolling device capable of being attached to or integrated in devices, suggesting an alternative to prior art solutions by providing a simple and reliable arrangement for moving the wheel element between a retracted and an extended position.

It has further been an object of the invention to find a solution that is simple to control and with a more compact construction than prior art solutions.

These and other characteristics of the invention will be clear from the following description of an exemplary embodiment, given as a non-restrictive example, with reference to the attached drawings.

### SUMMARY OF THE INVENTION

The present invention relates to a rolling device for a device to enable the moving of the device along a surface. The rolling device may typically be configured for engagement with a device such as piece of furniture of various kind, an euro pallet or other devices where the moving is facilitated by the use of one or more rolling devices. The rolling device may be mounted to the device in various ways; by integration of the rolling device into a cavity in the device to be moved (for instance a part of the furniture), by mounting the rolling device directly or indirectly to the device to be moved by the use of fixation means.

The rolling device comprises a bearing housing for accommodation of a wheel axle which carries a wheel element. The rolling device further comprises axle support members rotatably accommodated in the bearing housing. The wheel element may comprise various elements such as an ordinary wheel shape or having more of a ball shape or a spherical shape or any other shape capable of providing a rolling movement in interaction with a surface. The bearing housing may be provided as an open, semi closed or closed structure. In its most simplified form, the bearing housing may comprise two oppositely arranged frame structures for accommodation of the axle support structure. The frame structures may also have a bottom structure arranged with an opening configured for lifting and lowering at least a portion of the wheel element through the opening.

The wheel axle arranged for carrying the wheel element extends in between the axle support members. Each of the end portions of the wheel axle is connected (indirectly or directly) to each axle support members in an eccentric position displaced (radially) off-set from the rotational axis/center line of the axle support members.

The axle support members are arranged for supporting each of the two end portions of the wheel axle, and may typically be provided as two separate axle support members, where the rotation of each of the axle support members may occur independently or coordinated with each other. The axle support members may alternatively be arranged in a common arrangement as being part of the same entity or component, and may then appear as a wheel axle support arrangement comprising axle support members.

A drive motor, herein called the second drive motor, is arranged for rotation of the wheel element about the wheel axle. The second drive motor is arranged with a first motor part and a second motor part for conduction of relative rotation between the wheel and the wheel axle. The second drive motor typically comprises a first motor part connected to the wheel axle and a second motor part connected to the wheel element for rotation of the wheel element about the wheel axle. The first motor part may be a stator and the second motor part may be a rotor or vice versa. The drive motor could be a so-called hub motor.

A drive wheel is connected, for instance by a fixed connection, to one of the axle support members, it may also be possible to a connect a drive wheel to each of the axle support members. The drive wheel is arranged for the rotation of the axle support members to follow the rotation of the drive wheel. The rotational axis of the drive wheel may typically coincide essentially with the rotational axis of the axle support member. A first drive motor is arranged with a spindle in engagement with the drive wheel for rotation of the drive wheel.

It is also possible for the first motor to drive two drive wheels, if a drive wheel is connected to each of the axle support members. Alternatively, a first drive motor is provided for rotation of each of the axle support members.

The spindle rotates the drive wheel and thereby the axle support members relative to the bearing housing, for displacement of the wheel element by an eccentric movement between an extended position where at least a portion of the wheel element projects outside the bearing housing and a retracted position where the wheel element is located inside the bearing housing.

The drive motor may have a first driving direction for displacement of the wheel element into the retracted position and a second driving direction for displacement of the wheel element into the extended position.

The spindle may be arranged with threads, for instance a worm screw configuration, for intermeshing with a toothed configuration of the drive wheel, for instance a worm wheel, and the rotational axis of the spindle may be arranged orientated essentially perpendicular to the rotational axis of the drive wheel.

The drive wheel may be connected in a fixed manner to an outer surface of the axle support member, which outer surface is oriented exterior to the bearing housing, the drive motor may also be located exterior to the bearing house.

The rolling device could be said to have different operation or working modes such as a driving mode and a projection/retraction mode.

In the driving mode, the locking means are arranged in the locking position and the second drive motor then rotates the wheel element for movement along the surface.

In a projection/retraction mode of the rolling device the first drive motor displaces the wheel element by an eccentric movement between an extended position where at least a portion of the wheel element projects outside the housing and a retracted position where the wheel element is located inside the housing.

The wheel element needs to be in extended position for the second drive motor to rotate the wheel element for carrying out movement along the surface.

The rolling device may be switched between these operation modes as needed. In some circumstances the rolling device may be used only in the driving mode, while in other circumstances switching may occur on a regular basis.

The switching between extended and retracted position of the wheel element is also to be carried out according to need, the selection of and switching between these positions of the wheel may occur on a regular basis. It is also possible to employ the wheel element in a more or less permanent extended position if needed. The roller device would then offer the possibility of placing the wheel element in the retracted position as a potential without this occurrence needing to take place.

The fixed connection between the wheel axis and the axle support member may be provided by arranging the end portion of the wheel axis in a corresponding receiving recess in an end surface of the axle support member. The receiving recess may then be positioned off-center from the center axis of the axle support member.

For controlling the rolling device, a control unit may be included into the rolling device, or located elsewhere, for controlling the operation modes of the first drive motor and the second drive motor. The control unit may be arranged for receiving control signals for operation of the rolling device from a remote control, computer, cell phone or by voice-activation. Alternatively, the control signals may be received from a control button on the rolling device or in the vicinity or distant to the rolling device.

To obtain efficient rotation of the axle support member relative the bearing housing each of the axle support members may typical have the configuration of a spherical disc member and the mounting openings may be arranged as a corresponding through holes with a circular cross section. Other configuration of the axle support members suitable for enabling rotation may also be chosen, for instance cylindrical shapes, various spherical or circular shapes or other shapes capable of conducting rotary motion.

One or both of the axle support members may be received in a mounting opening in the bearing housing, wherein the mounting opening then may be defined by an internal surrounding wall configured in the bearing housing.

### BRIEF DESCRIPTION OF THE DRAWINGS

In the following, embodiments of the present invention will be described in detail with reference to the enclosed drawings, where

FIG. 1 is a schematic perspective view of the rolling device in accordance with the invention with the wheel element in projected position.

FIG. 2 is a schematic side view of the rolling device as shown in FIG. 1.

FIG. 3 shows the rolling device of FIG. 2 beginning the retraction of the wheel element.

FIG. 4 is a schematic side view of the rolling device as shown in FIG. 3.

FIG. 5 shows the rolling device with the wheel element in retracted position.

FIG. 6 is a schematic side view of the rolling device as shown in FIG. 5.

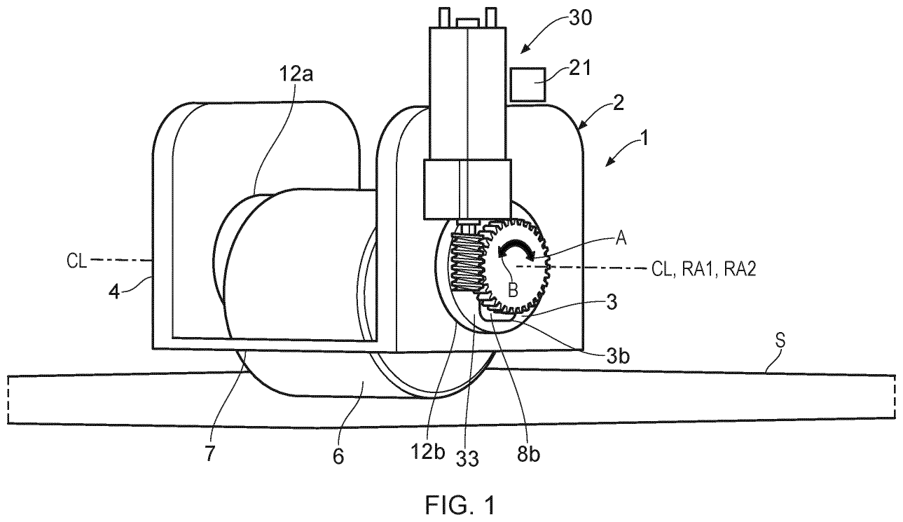

A rolling device 1 for mounting or integration into a device to be moved such as furniture, euro pallets or other movable structures is shown in FIGS. 1 and 7. The rolling device 1 has a bearing housing 2 shown in figs as a semi closed structure having two opposite frame structures here configured as side walls 4 for accommodation of the axle support members 3 and a bottom structure 5 arranged with an opening 7 configured for lifting and lowering at least a portion of the wheel element 6 through the opening 7.

The wheel element 6 is rotatably arranged on a wheel axle shown by end portions 8b and a drive motor referred to as a second drive motor (not shown) herein. The second drive motor is arranged within the wheel element for rotation of the wheel element 6 about the wheel axle. The second drive motor may be a so-called hub motor or any other motor capable of rotating the wheel element 6 relative to the wheel axle 8. The second drive motor typically has a first motor part connected to the wheel axle 8 and a second motor part connected to the wheel element 6 for causing relative rotation between the wheel element 6 and the wheel axle upon actuation of the drive motor. The first motor part may be a stator and the second motor part may be a rotor or vice versa.

The wheel axle has end portions (only end portion 8b is visible in the figs) each inserted into receiving recesses (only receiving recess 3b is visible in the figs) through the axle support members 3 thereby forming a fixed connection between the wheel axle 8 and the axle support members 3. The end portions 8b are connected to each axle support members in an eccentric position EP displaced offset from the center line CL of the axle support members 3. The center line is also the rotational axis of the axle support members 3.

The axle support members 3 are each rotatably accommodated in corresponding mounting openings 12a, 12 b here shown as spherical hollows or through holes in the bearing housing 2. The axle support members 3 are shown configured as circular disc members, but also other rotational bodies allowing rotation relative to the bearing housing 2 may be used in this application. The axle support member 3 is arranged in the mounting opening 12b so that an outer circular surface 33 of the axle support member is oriented exterior the bearing housing 2. The drive wheel 32 is connected to this outer surface 33.

A first drive motor 30, in the figs. located exterior to the bearing housing, is arranged for actuation of the displacement of the wheel element between an extended position where at least a portion of the wheel element 6 projects outside the bearing housing 2 and a retracted position where the wheel element is located inside the bearing housing 2. The first motor 30 has a spindle 31 configured as a worm screw in the figs. The spindle 31 is arranged in engagement with the drive wheel 32. The threads of the spindle 31 intermesh with the toothed configuration to the drive wheel 32 which is arranged as worm wheel in the figs. The drive wheel 32 is connected to one of the axle support members 3 in an arrangement that ensure that the axle support member 3 follow the rotation of the drive wheel 32, for instance by a fixed connection. The rotational axis of the spindle 31 is orientated essentially perpendicular to the rotational axis of the drive wheel 32.

The rotational axis RA1 of the drive wheel 32 coincides essentially with the rotational axis RA2 of the of the axle support member 3. These rotational axes are shown to coincide with the center line CL illustrated in the figs.

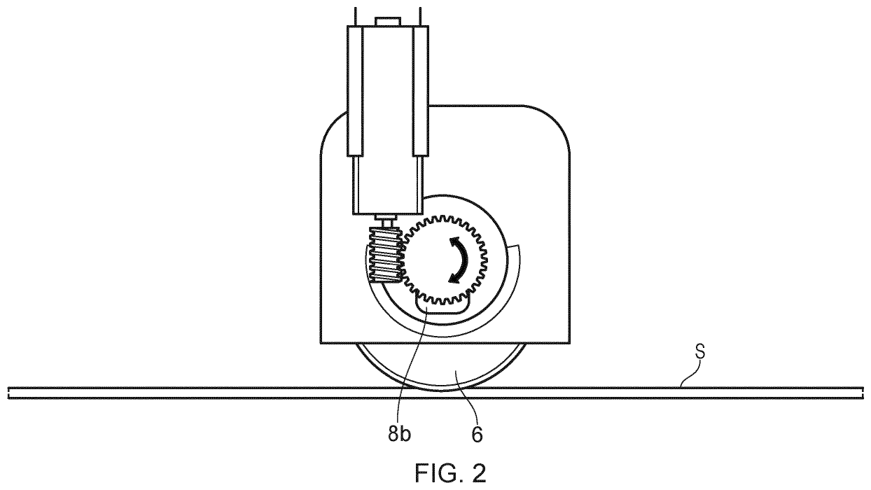

FIGS. 1, 2 illustrate the situation where a portion of the wheel element 6 projects outside the housing and the second drive motor may be actuated to rotate the wheel element 6 for moving the rolling device 1 along a surface S. The first drive motor 30 is operated into a first driving direction, thereby rotating the drive wheel 32 and the axle support member 3 in a first direction as illustrated by arrow A.

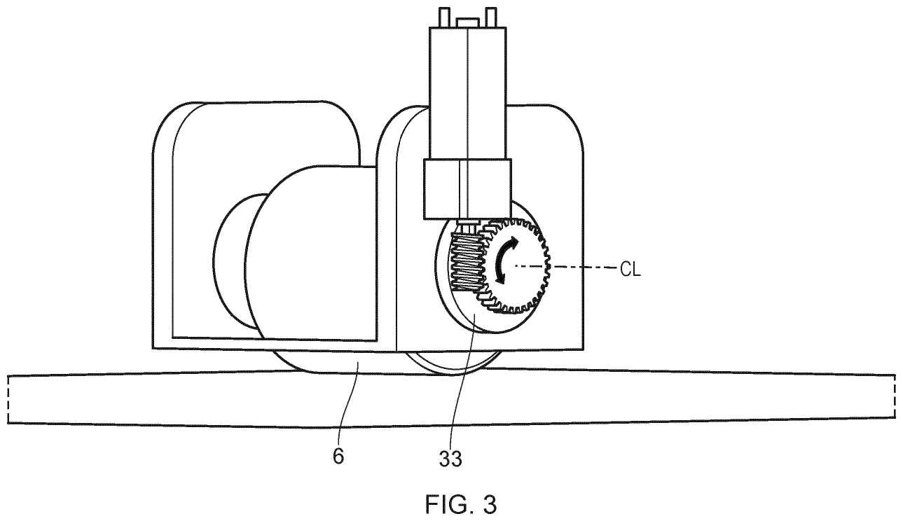

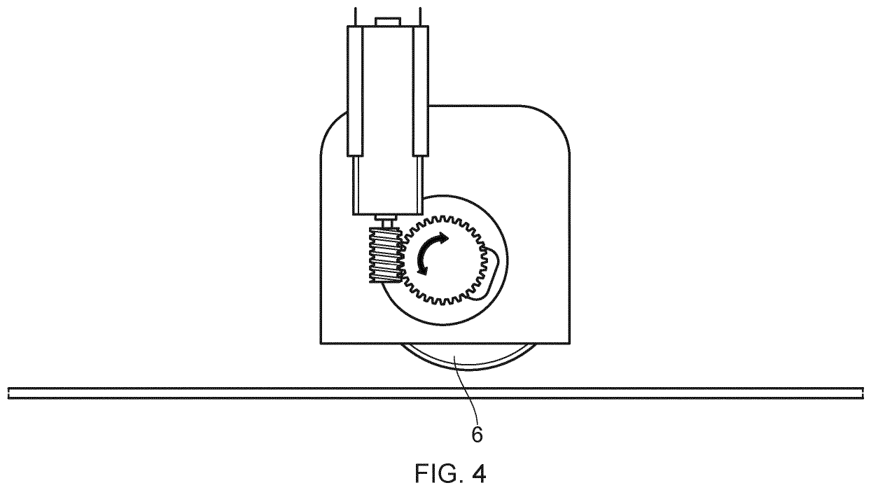

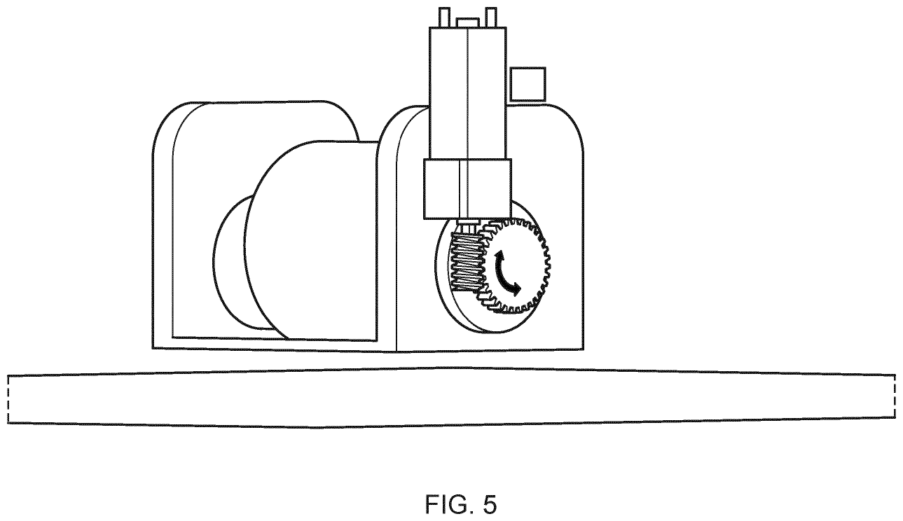

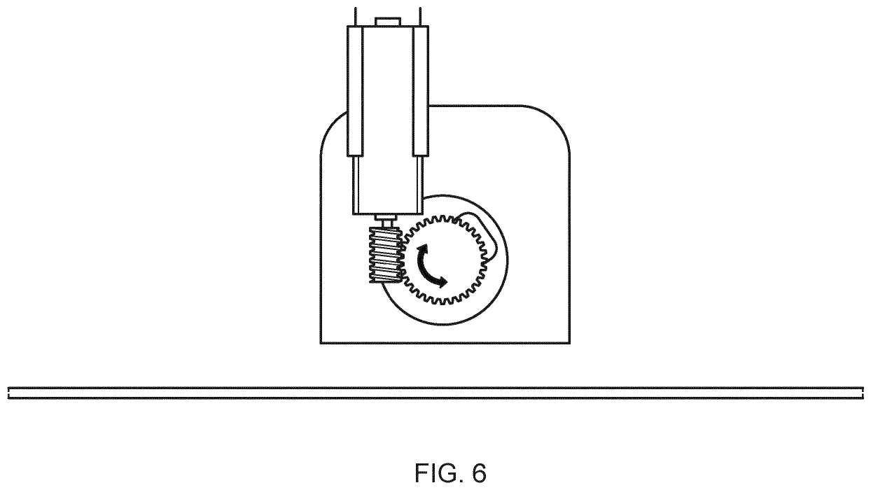

The eccentric position of the wheel axle 8 causes the wheel element 6 to be displaced by an eccentric movement from an extended position where at least a portion of the wheel element projects outside the housing, as illustrated in FIGS. 1 and 2, to a partly retracted position of the wheel element 6 as illustrated in FIG. 3 and FIG. 4, and further to the fully retracted position where the wheel element is located inside the bearing housing 2, and the bearing housing 2 rests against the surface S as illustrated in FIGS. 5 and 6.

The first drive motor also has a second driving direction for displacement of the wheel element 6 into extended position (FIGS. 1 and 2) from the retracted position as illustrated in FIGS. 5 and 6.

A control unit 20 is provided for controlling the rolling device. The control unit receives control signals for operation of the drive motor from a remote control, computer, cell phone or by voice-activation

1. A rolling device for a device to enable the moving of the device along a surface, wherein the rolling device comprises:
a bearing housing for accommodation of a wheel axle carrying a wheel element,
axle support members rotatably accommodated in the bearing housing, wherein each axle support member supports an end portion of the wheel axle,
the wheel axle carrying the wheel element extends in between the axle support members, with each of the end portions of the wheel axle connected to each axle support members in an eccentric position displaced off-set from the rotational axis/center line of the axle support members,
a drive wheel connected to one of the axle support members for the axle support member to rotate following the rotation of the drive wheel,
a first drive motor arranged with a spindle in engagement with the drive wheel to rotate the drive wheel and thereby the axle support member relative to the bearing housing, for displacement of the wheel element by an eccentric movement between an extended position where at least a portion of the wheel element projects outside the bearing housing and a retracted position where the wheel element is located inside the bearing housing.

2. A rolling device in accordance with claim 1, wherein the spindle is arranged with threads configured for intermeshing with a toothed configuration of the drive wheel, and the rotational axis of the spindle is orientated essentially perpendicular to the rotational axis of the drive wheel.

3. A rolling device in accordance with claim 1, wherein the drive motor has a first driving direction for displacement of the wheel element into the retracted position, and a second driving direction for displacement of the wheel element into the extended position.

4. A rolling device in accordance with claim 1, wherein the drive wheel is connected in a fixed manner to an outer surface of the axle support member, which outer surface is oriented exterior to the bearing housing.

5. A rolling device in accordance with claim 1, wherein a second drive motor is located within the wheel element for rotation of the wheel element relative to the wheel axle.

6. A rolling device in accordance with claim 1, wherein a control unit controls the rolling device and the control unit receives control signals for operation of the first and/or second drive motor from a remote control, computer, cell phone or by voice-activation.

7. A rolling device in accordance with claim 1, wherein at least one of the axle support members has the configuration of a circular disc member and the mounting opening is arranged as a corresponding circular through opening.

8. A rolling device in accordance with claim 1, wherein at least one of the axle support members is received in a mounting opening in the bearing housing, wherein the mounting opening is defined by an internal surrounding wall configured in the bearing housing.

9. A rolling device in accordance with claim 1, wherein the drive motor is located exterior to the bearing housing.
